(19) United States
(12) Patent Application Publication
(10) Pub. No.: US 2006/0107600 A1
(43) Pub. Date: May 25, 2006

(54) Rear slider window assembly for vehicle

(76) Inventors: David E. Nestell, Spring Lake, MI (US); Robert E. Bloomfield, West Olive, MI (US); Steven C. Dubay, Rockford, MI (US); Darin J. Snider, Holland, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/263,221

(22) Filed: Oct. 31, 2005

Related U.S. Application Data
(60) Provisional application No. 60/624,090, filed on Nov. 1, 2004.

(51) Int. Cl. E05D 15/06

(52) U.S. Cl. 49/413

(57) ABSTRACT

A slider window assembly for a vehicle includes at least one fixed window panel, a movable window panel and at least one sealing member. The fixed window panel has a perimeter edge that defines at least a portion of an opening. The movable window panel is movable relative to the fixed window panel to open and close the opening. The movable window panel and the fixed window panel have opposed surfaces. The sealing member is attached to one of the opposed surfaces and slidably engages the other of the opposed surfaces as the movable window panel is moved relative to the fixed window panel.

### CROSS REFERENCE TO RELATED APPLICATION

The present application claims benefit of U.S. provisional application, Ser. No. 60/624,090, filed Nov. 1, 2004 (Attorney Docket DON02 P-1180), which is hereby incorporated herein by reference in its entirety.

### FIELD OF THE INVENTION

The present invention relates to windows for vehicles and, more particularly, to sliding windows, such as horizontal slider windows for pickup trucks and the like.

### BACKGROUND OF THE INVENTION

It is known to provide a slider window assembly for a rear opening of a truck. Conventional slider window assemblies for rear openings of trucks or the like typically include three or more panels, such as two fixed window panels and at least one slidable window panel. The fixed window panels are supported in a spaced relationship, for example, by a support, such as a frame. The slidable window panel (or panels) is/are supported by rails, which are typically mounted to the support.

The trend in vehicle windows is to form a pre-assembled modular assembly that can be installed to the vehicle as a single component. In addition, more recently, window assemblies are often retained in the vehicle by studs or clips that are encapsulated or otherwise attached to the window assembly. As a result, the window assembly comprises a pre-assembled unit that is easier to handle during shipping and installation. Examples of such pre-assembled units are shown in U.S. Pat. Nos. 4,606,159; 4,723,809; 5,853,895; 6,086,138; and 6,293,609, which are incorporated by reference herein in their entireties.

Such window assemblies or modules typically include a pair of horizontal rigid rails or bracing rails for guiding the horizontal sliding window, and a pair of generally vertical and rigid interconnecting rails that are interconnected between the upper and lower bracing rails. The rails thus form an “H-frame” that is applied to or bonded to or attached to or molded on the respective window panels. The frame may be bulky and may require two operators to handle and position at the appropriate location on the window panels. Also, such H-frame configurations require large tonnage presses and utilize complex tooling to form the frame portions together, and thus add to the cost of manufacturing the window modules.

Therefore, there is a need in the art for a window assembly or module that overcomes the shortcomings of the prior art.

### SUMMARY OF THE INVENTION

The present invention provides a window assembly that includes a slidable window panel that slides or moves to open and close an opening in the window assembly. The slidable window panel is movable relative to a pair of spaced apart fixed windows or panels, and may slide along rails or channels attached or affixed or bonded to the fixed window panels. The fixed window panels and/or the slidable window panel include a seal member that is adhered or bonded or molded to the respective panel and along a perimeter portion or region of the panel. The seal member slides along the other panel as the slidable window panel slides along the rails so that the slidable window panel is substantially sealed relative to the fixed window panel or panels as the slidable window panel is moved between its opened and closed positions.

According to an aspect of the present invention, a slider window assembly for a vehicle includes at least one fixed window panel, a movable window panel and at least one sealing member. The fixed window panel has a perimeter edge that defines at least a portion of an opening. The movable window panel is movable relative to the fixed window panel to open and close the opening. The movable window panel and the fixed window panel have opposed surfaces. The sealing member is attached to one of the opposed surfaces and slidably engages the other of the opposed surfaces as the movable window panel is moved relative to the fixed window panel.

The sealing member may be attached to a surface of the fixed window panel, and may slidably engage the surface of the movable window panel as the movable window panel is moved. The sealing member may comprise an extruded elastomeric sealing member. The sealing member may be adhesively attached to the surface of the opposed surface.

The window assembly may include an upper rail member and a lower rail member attached to the fixed window panel. The movable window panel moves along the upper and lower rail members.

The fixed window panel may comprise first and second fixed window panels spaced apart from one another with the opening defined therebetween. The window assembly may include upper and lower panes or panels positioned between the first and second fixed window panels and defining the upper and lower margins of the opening.

Therefore, the present invention provides a slider window assembly for a vehicle that does not include rigid frame portions along the junction or seal between the fixed and movable or slidable window panels. The window assembly includes a seal member that is adhesively attached to or bonded to one of the opposed surfaces of the slidable window panel and the fixed window panel or panels to provide a sliding seal between the panels. The window assembly of the present invention thus provides a sliding window assembly with reduced frame portions and thus provides a reduced cost and reduced weight window assembly. The upper and lower rails of the window assembly of the present invention may be formed side by side in molding cavities so that multiple rails may be formed during a single molding process, thereby substantially enhancing the molding process and facilitating implementation of reduced cost molding equipment.

These and other objects, advantages, purposes and features of the present invention will become apparent upon review of the following specification in conjunction with the drawings.

### BRIEF DESCRIPTION OF THE DRAWINGS

FIG. 1 is a rear elevation of a horizontal slider window assembly in accordance with the present invention, as viewed from rearward of the window assembly when the window assembly is attached to a vehicle;

FIG. 2 is a front elevation of the window assembly of FIG. 1;

FIG. 3 is a perspective sectional view of the window assembly taken along the line III-III in FIG. 2;

FIG. 4 is a perspective sectional view of the window assembly taken along the line IV-IV in FIG. 2;

FIG. 5 is a perspective view of the window panels and extruded seal between the fixed and movable window panels of the window assembly of FIGS. 1 and 2;

FIG. 6 is a perspective sectional view similar to FIG. 4 showing another window assembly in accordance with the present invention;

FIG. 6A is a perspective sectional view similar to FIG. 4 showing another window assembly in accordance with the present invention;

FIG. 7 is a perspective view of another horizontal slider window assembly in accordance with the present invention, as viewed from an interior of the vehicle when the window assembly is attached to a vehicle;

FIG. 8 is a plan view of the horizontal slider window assembly of FIG. 7;

FIG. 9 is a sectional view of the horizontal slider window assembly taken along the line A-A in FIG. 8;

FIG. 10 is a sectional view of the horizontal slider window taken along the line A′-A′ in FIG. 8;

FIG. 11 is a sectional view of the horizontal slider window assembly taken along the line B-B in FIG. 8;

FIG. 12 is a sectional view of the horizontal slider window assembly taken along the line B′-B′ in FIG. 8;

FIG. 13 is a sectional view of the horizontal slider window assembly taken along the line C-C in FIG. 8;

FIG. 14 is a sectional view of the horizontal slider window assembly taken along the line D-D in FIG. 8;

FIG. 15 is a sectional view of the horizontal slider window assembly taken along the line E-E in FIG. 8;

FIG. 16 is a sectional view of the horizontal slider window assembly taken along the line F-F in FIG. 8;

FIG. 17 is a sectional view of the horizontal slider window assembly taken along the line G-G in FIG. 8;

FIG. 18 is a sectional view of the horizontal slider window assembly taken along the line H-H in FIG. 8;

FIG. 19 is a sectional view of the horizontal slider window assembly taken along the line I-I in FIG. 8;

FIG. 20 is a sectional view of the horizontal slider window assembly taken along the line J-J in FIG. 8;

FIG. 21 is a perspective view of a lower portion of the horizontal slider window assembly of FIGS. 7 and 8, showing drainage passageways formed in the lower frame;

FIG. 22 is an enlarged perspective view of one of the drainage passageways of FIG. 21;

FIG. 23 is a perspective view of another horizontal slider window assembly in accordance with the present invention;

FIG. 24 is a plan view of the horizontal slider window assembly of FIG. 23;

FIG. 25 is a sectional view of the horizontal slider window assembly taken along the line K-K in FIG. 24;

FIG. 26 is a sectional view of the horizontal slider window assembly taken along the line L-L in FIG. 24;

FIG. 27 is a sectional view of the horizontal slider window assembly taken along the line M-M in FIG. 24;

FIG. 28 is an enlarged perspective view of a joint between the lower frame portion and a J-ring of the horizontal slider window assembly of FIGS. 23 and 24;

FIG. 29 is a perspective view of another horizontal slider window assembly of the present invention, with an illumination source at an upper header region of the window assembly;

FIG. 30 is an enlarged perspective view of the upper header region of the horizontal slider window assembly of FIG. 29; and

FIG. 31 is a partial sectional and perspective view of the window assembly of FIGS. 29 and 30.

### DESCRIPTION OF THE PREFERRED EMBODIMENTS

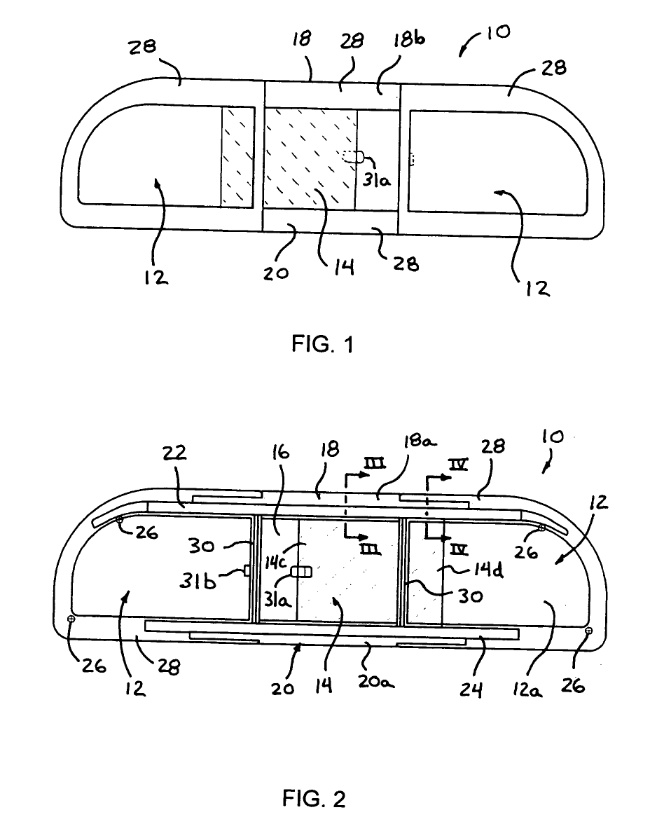

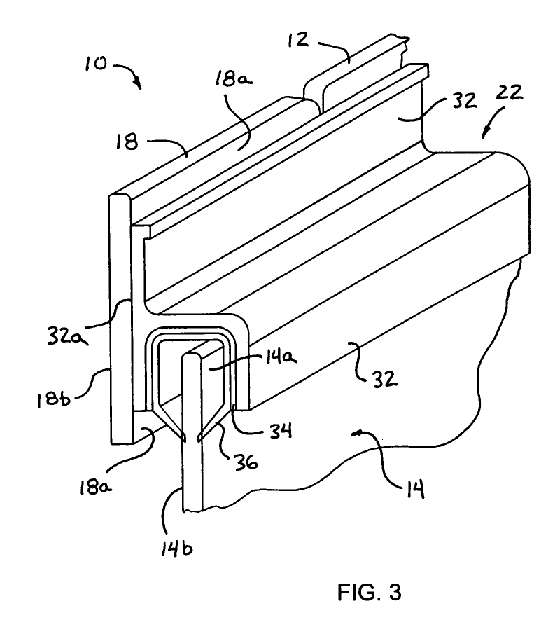

Referring now to the drawings and the illustrative embodiments depicted therein, a slider window assembly 10 (FIGS. 1 and 2) may be mounted at an opening of a vehicle (not shown). Slider window assembly 10 is particularly suitable for use as a rear window or backlite of a vehicle, such as a light truck, such as a pick-up truck or the like. Slider window assembly 10 comprises a modular assembly that includes a pair of fixed window panes or panels 12 and a movable or slidable window pane or panel 14 that slides or moves generally horizontally relative to the fixed window panels 12 to open and close the slider window assembly, as discussed below. Although shown and described as a horizontal slider window, aspects of the present invention may be equally suited for application to a vertical slider window (where the movable window panel moves vertically relative to the fixed window panels), without affecting the scope of the present invention. Also, the window assembly or assemblies of the present invention may utilize aspects of the window assemblies described in U.S. patent applications, Ser. No. 10/697,372, filed Oct. 29, 2003 by Galer for HORIZONTAL SLIDER WINDOW ASSEMBLY (Attorney Docket DON02 P-1121); Ser. No. 10/454,040, filed Jun. 4, 2003 by Galer et al. for SLIDER WINDOW ASSEMBLY (Attorney Docket DON02 P-1095); Ser. No. 10/408,047, filed Apr. 4, 2003 by Galer for SLIDER WINDOW ASSEMBLY (Attorney Docket DON02 P-1083); and/or Ser. No. 10/113,056, filed Apr. 1, 2002 by Nestell et al. for HORIZONTAL SLIDER WINDOW ASSEMBLY (Attorney Docket DON02 P-965), which are hereby incorporated herein by reference.

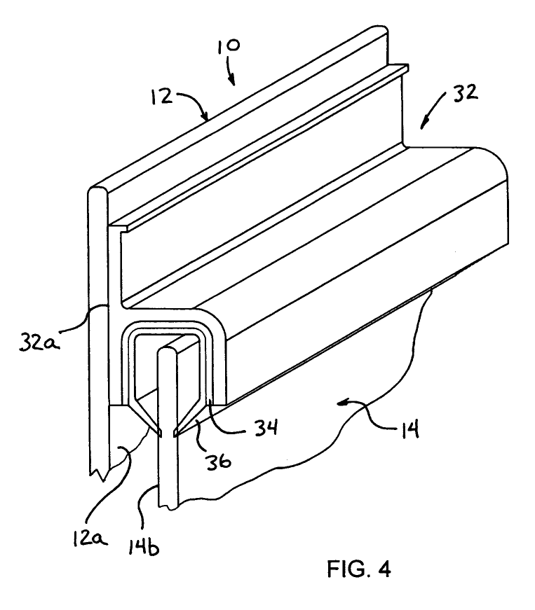

The fixed window panels 12 are spaced apart and positioned at opposite sides of the window assembly 10, with an opening or gap 16 defined between the fixed window panels 12. Opening 16 is opened and closed by moving the slidable window panel 14, which is movably positioned at the inner surfaces 12a of fixed window panels 12. An upper pane or panel 18 and a lower pane or panel 20 (FIGS. 2 and 3) may be provided along the upper and lower portions of the window assembly 10 and between the side fixed window panels 12, so as to define the upper and lower borders or margins of the window opening 16. As can be seen in FIG. 3, the inner or interior surfaces 18a, 20a of panels 18, 20 may be generally flush with the inner surfaces 12a of side fixed window panels 12, so that the upper and lower rails or channels 22, 24 (discussed below) may be adhered to or attached to or bonded to or molded to the inner surfaces of the fixed window panels 12 and the inner surfaces of the respective panel 18, 20 to provide the channels for the upper and lower edges of the slidable window panel 14 along the window assembly. The side panels 12 and panels 18, 20 thus function to define the opening 16 over which slidable window panel 14 may move to open and close the window assembly. The panels may comprise polymeric or plastic panels, such as dark or black polycarbonate hard coated panels or the like. When attached to the rails or channels, the exterior or outer surfaces 12c of fixed window panels 12 may be substantially flush or co-planar with the outer surfaces 18b, 20b of panels 18, 20 to provide a substantially continuous or flush appearance at the exterior of the window assembly.

Preferably, the inner surfaces of the perimeter portions of fixed window panels 12 and/or the inner surfaces of the panels 18, 20 provide a mounting surface inward of the perimeter for mounting window assembly 10 in an opening in a vehicle body, such as by direct bonding with the vehicle body or frame. Window assembly 10 is preferably directly bonded to the body of the vehicle by an adhesive, such as a urethane adhesive, including one part or two part urethane adhesive, an epoxy adhesive, an acrylic adhesive, a silicone adhesive, a polyvinylbutyral adhesive, or the like. For example, window assembly 10 may be bonded in the vehicle by a bead of adhesive that is located between the vehicle body panel and the inner surfaces of the perimeter portions of fixed window panels 12 and panels 18, 20 so as to provide a substantially flush mounting of window assembly 10 in the vehicle. As used herein, “flush mounting”, in reference to the position of the window assembly in the vehicle body, means that at least the fixed window panels appear to lay in the same plane as the vehicle body or, in the case of a curved vehicle body, lies in the curved plane of the vehicle body and generally follows the contours of the vehicle body. The window assembly may include one or more locating clips 26 positioned around and attached to or bonded to the perimeter of the window panels and of the window assembly to facilitate proper positioning of the window assembly at the opening in the vehicle body. Optionally, the window assembly may include a frame portion or the like (not shown) for receiving the window panels and panes and for mounting to the vehicle body, without affecting the scope of the present invention.

As shown in FIGS. 1 and 2, fixed window panels 12 may include a frit layer 28, which extends around the outer peripheral portions of fixed window panels 12, such as on inner surfaces 12a. Optionally and preferably, frit layer 28 also extends along the inner edges or inner perimeter regions 12b to thereby conceal the location of the vertical seals 30 (discussed below). Frit layer 28 is substantially opaque (such as a dark color or black) and, therefore, provides a concealing function and may further facilitate the adhesion or bonding of fixed window panels 12 to the vehicle body. The rails and/or seals and other components may be bonded to the window panels, such as via curing of a bonding or an adhesive material and utilizing bonding processes of the types described in U.S. Pat. Nos. 6,298,606; 6,128,860; 5,966,874; 5,704,173; and 5,551,197, which are hereby incorporated herein by reference.

In the illustrated embodiment, slidable window panel 14 is supported for horizontal movement between panels 12 and over opening 16 of window assembly 10. As can be seen with reference to FIGS. 2-4, slidable window panel 14 may be guided and supported by a guide, such as a pair of substantially rigid or bracing rails 22, 24 that are mounted to the inner surfaces 12a of fixed window panels 12 and to the inner surfaces 18a, 20a of panels 18, 20, such as, for example, by an adhesive or the like. For example, rails 22, 24 may be mounted to the inner surfaces 12a of fixed window panels 12 and the inner surfaces 18a, 20a of panels 18, 20, by an adhesive, such as a urethane adhesive, including a one part or two part urethane adhesive, an epoxy adhesive, an acrylic adhesive, a polyvinylbutyral adhesive, a silicone adhesive, or the like. Reference is made to U.S. Pat. Nos. 4,364,214; 4,364,595; 6,299,255; and 6,220,650, which are incorporated by reference in their entireties, for examples of suitable adhesives. Alternately, it is envisioned that the rails may be molded onto the fixed window panels and the upper and lower panels, depending on the particular application of the window assembly. Each rail 22, 24 provides or has formed therein a longitudinal channel or groove, which guides slidable window panel 14 along the rails between its opened and closed positions.

In the illustrated embodiment, the upper traveling edge 14a and lower traveling edge (not shown) of slidable window panel 14 extend into the respective grooves of rails 22, 24. In this manner, when panel 14 is moved to its closed position over opening 16, panel 14 is offset inwardly from the plane of the fixed window panels 12 and panels 18, 20 to form a “sub-flush” mounting arrangement for panel 14 with respect to fixed window panels 12 and panels 18, 20. When so arranged, the outer surface 14b of slidable window panel 14 opposes the inner surfaces 12a, 18a, 20a of the perimeter regions of the fixed window panels 12 and panels 18, 20. As used above, the term “inwardly” refers to the relative position, for example, of the slidable window panel with respect to the fixed window panels when the window assembly is mounted in the vehicle. Similarly, references to “inner”, “outer”, and “exterior” are used as nomenclature relative to when the window assembly when mounted in the vehicle.

Slidable window panel 14 moves along rails 22, 24 to open and close the window assembly. The slidable window panel may be opened and closed either manually or by an onboard motion imparting system or drive assembly, such as by a drive assembly of the types described in U.S. Pat. Nos. 4,920,698; 4,995,195; 5,146,712; 5,531,046; 5,572,376; 6,119,401; and 6,955,009, and U.S. patent applications, Ser. No. 10/454,040, filed Jun. 4, 2003 (Attorney Docket DON02 P-1095); and/or Ser. No. 10/697,372, filed Oct. 29, 2003 by Galer for HORIZONTAL SLIDER WINDOW ASSEMBLY (Attorney Docket DON02 P-1121), which are hereby incorporated herein by reference. In the illustrated embodiment, the slidable window panel 14 may be manually movable along the rails 22, 24. As shown in FIG. 2, slidable window panel 14 may include a latch or locking device 31a that latches to or connects to a catch or locking device 31b at one of the fixed window panels 12 to retain the slidable window panel 14 in its closed position relative to the fixed window panels 12. The latch and catch may be attached or adhered or bonded to the respective window panels, such as via an adhesive or the like.

Referring to FIGS. 3 and 4, the upper and lower rails 22, 24 comprise generally U-shaped or channel-shaped members with downwardly and upwardly depending flanges, respectively. As noted above, rails 22, 24 are preferably bonded to the inner surfaces 12a, 18a, 20a of fixed window panels 12 and panels 18, 20. Rails 22, 24 are preferably formed from a substantially rigid material, such as a polymeric material, including glass filled nylon, PVC, or the like. Rails 22, 24 may also or otherwise comprise a metallic material or may comprise a composite material, such as a filled polymeric or a metal member that is encapsulated in plastic, for example. In the illustrated embodiment of FIGS. 3 and 4, the rails (only the upper rail 22 is shown in FIGS. 3 and 4, but the lower rail may be similarly formed) comprise encapsulated rails, with a polymeric or PVC rail housing or encapsulation 32 encompassing or encapsulating an inner rail 34, which may comprise an extruded polymeric rail or metallic rail, and which may receive an extruded seal or sealing member 36. The encapsulation 32 may be molded over and partially around the steel or substantially rigid plastic rail 34, and the seal 36 may be pressed into and along the channel of the inner rail 34 to complete the assembly process of the rail 22, 24. The encapsulation 32 may include a mounting flange or surface or attaching surface 32a for adhering or bonding to the surface of the fixed window panels 12 and panels 18, 20.

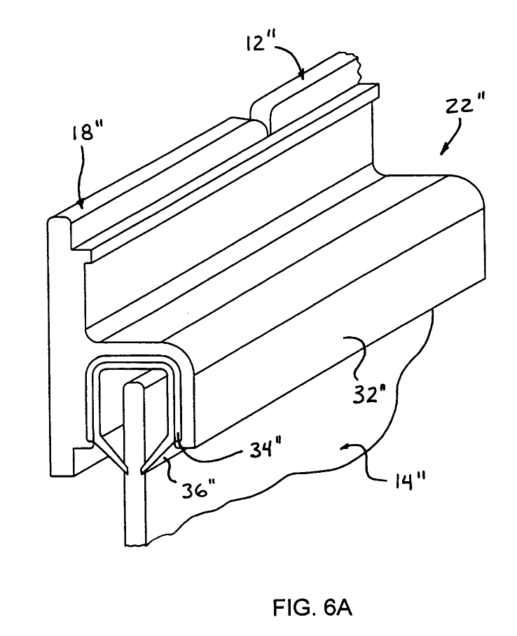

Optionally, and with reference to FIG. 6, the substantially rigid metallic or steel or plastic rail or channel 34′ of a rail 22′ may be co-extruded with the sealing member 36′, and the outer plastic rail or encapsulation 32′ may be molded over the co-extruded rail and seal component. The seal thus may be coextruded onto and thus formed on the steel rail and the encapsulation may be molded over the pre-formed rail and seal. Such an arrangement and process may provide a reduced cost rail by providing a reduction in manual labor, since the seal does not have to be pressed into the rail during a separate installation process. Also, such an arrangement and process may provide enhanced sealing by coextruding the seal and inner rail together, and provides an integration of pieces and thus a reduction of parts at the manufacturing or assembly plant or facility. The coextrusion of the seal integral with the rail or channel thus may provide enhanced sealing characteristics and obviates the need to coextrude and roll form two separate parts and assemble the parts together prior to the encapsulation of the rail and seal components.

It should be understood that the slide or guide or bracing rails or channels may have other configurations while still achieving the same guiding function for slidable window panel 14. For example, the mounting flanges of the rails may be truncated or eliminated (such as shown at mounting flange 22a′ of upper rail 22′ in FIG. 6), with the web of the rail providing the mounting surface, for example. Optionally, and as can also be seen with reference to FIG. 6, the flange 22a′ may include a recessed mounting surface 22b′ for receiving an adhesive 38 or the like for mounting the rail 22′ to fixed window panels 12 and panel 18 (not shown in FIG. 6). Although only the upper rail 22′ is shown in FIG. 6, the lower rail may be formed in a similar manner.

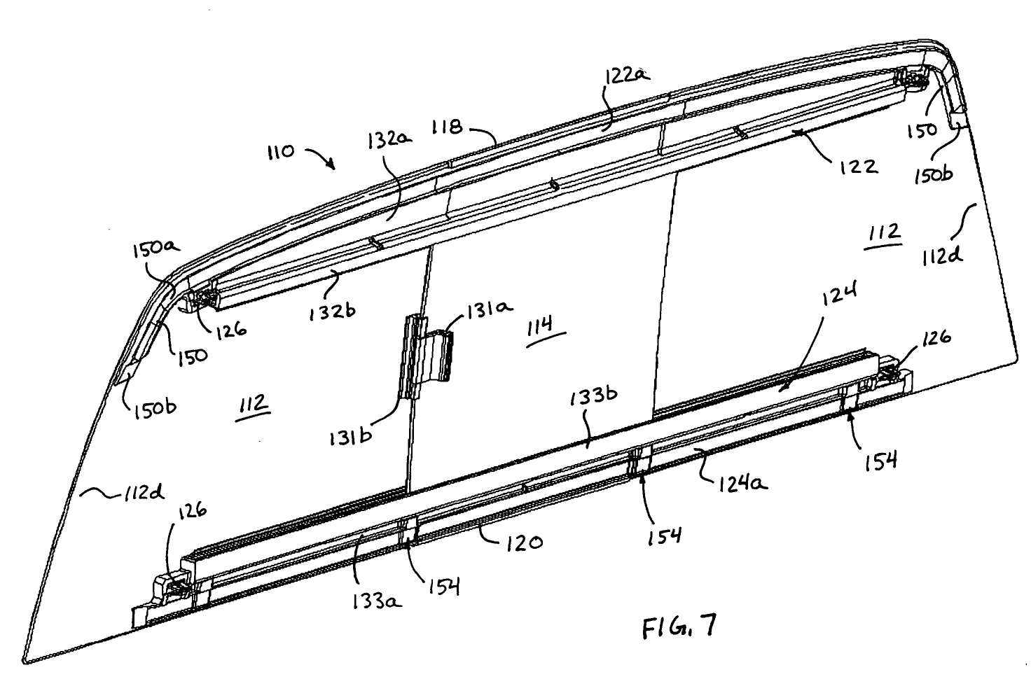

Optionally, the upper and/or lower panels or partial panels may be integrally formed with the respective rails so that the separate panels 18, 20 may not be needed (such as shown in FIG. 6A and/or as discussed below with respect to FIGS. 7-22). For example, and with reference to FIG. 6A, an upper rail 22″ (only upper rail 22″ is shown in FIG. 6A, but it should be understood that the lower rail may be substantially similar in construction and function as the upper rail 22′) may be substantially similar in construction as upper rail 22, discussed above, but may be integrally molded or extruded with an upper perimeter face panel 18″ along the center portion of the window assembly. Accordingly, when the upper rail 22″ is bonded to the surface of the fixed window panels 12″, the integrally molded perimeter panel portion 18″ fits generally between the opposed end portions or edges of the fixed window panels 12″ to form the generally flush appearance similar to that described above with respect to window assembly 10. The fixed and movable window panels 12″, 14″ and the channel or encapsulation 32″, inner rail 34″ and seal 36″ of upper rail 22″ may be substantially similar to the window panels 12, 14 and the channel 32, inner rail 34 and seal 36 of upper rail 22, described above, such that a detailed discussion of the window panels, channels, inner rails and seals of the window assemblies will not be repeated herein.

In the illustrated embodiment of FIGS. 1-5, the upper traveling edge 14a (FIG. 3) and the lower traveling edge (not shown) of slidable window panel 14 extend into the respective channels or grooves provided by rails 22, 24 so that panel 14 is guided and optionally supported therein for generally horizontal movement. In addition, seals 36 are preferably positioned in the respective grooves of rails 22, 24 to seal slidable window panel 14. Seals 36 may comprise generally U-shaped seals or comprise double-L seals, Y-seals, V seals, C-shaped seals, bulbous seals, or one of a number of different shaped-seals, and preferably comprises a polypropylene material (PPE) or EPDM. Examples of suitable seals can be found in U.S. Pat. Nos. 6,220,650; 6,299,235; 6,394,529; 6,572,176; and 6,729,674, which are incorporated by reference herein in their entireties.

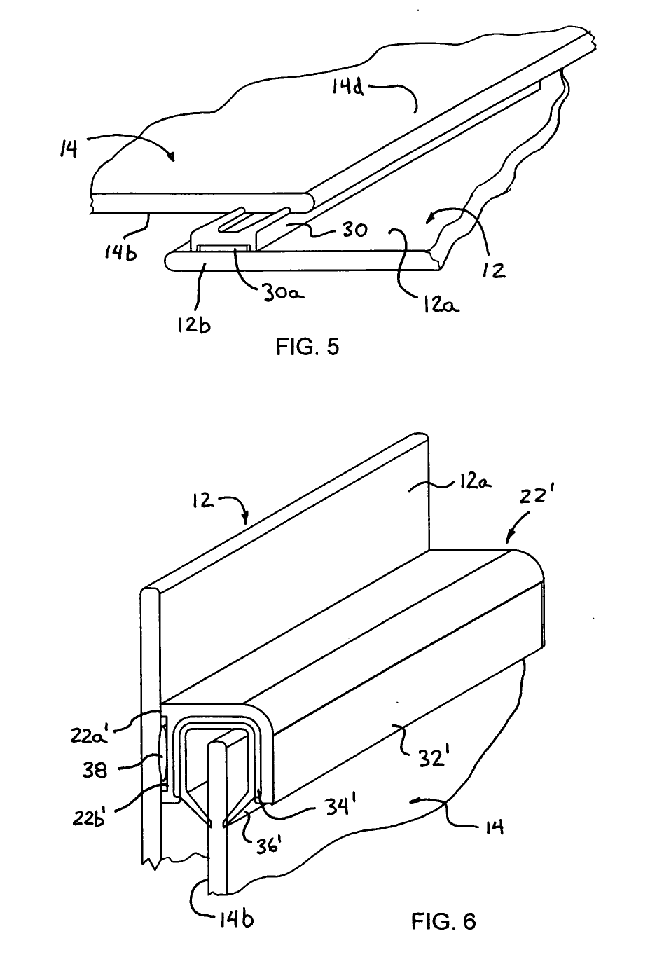

The outer or opposed surface 14b of slidable window panel 14 opposes the inner surfaces 12a, 18a, 20a of the perimeter regions of the fixed window panels and upper and lower panels, and is substantially sealed relative to the inner surfaces 12a of the fixed window panels 12 via the rails 22, 24 and seals 36 and one or more vertical seals 30. For example, when in the closed position, leading and trailing edges 14c and 14d of slidable window panel 14 are sealingly engaged by vertical seals 30 at both fixed window panels 12. As shown in FIG. 5, seals 30 may be adhered to the inner or opposed surface 12a of a respective fixed window panel 12, such as along the perimeter edges 12b of the fixed window panels 12. The outer or opposed surface 14b of slidable window panel 14 thus slides along and seals against seals 30 of fixed window panels 12 as the slidable window panel 14 is moved between its opened and closed positions. Alternately, and less desirably, the vertical seals may be mounted at the leading and trailing edges of the slidable window panel.

The seals 30 may comprise an extruded EPDM material or the like, and may be adhered to the inner surfaces of the fixed window panels, such as via a pressure sensitive or PS tape 30a or the like. The seals may provide a vertical seal along the sides of the opening 16 to seal against the slidable window panel 14. Seals 30 may comprise Y-shaped seals or bulbous seals or one or more of the various other shaped seals noted above, without affecting the scope of the present invention. Reference is made to U.S. patent application, Ser. No. 10/113,056, filed Apr. 1, 2002, entitled HORIZONTAL SLIDER WINDOW ASSEMBLY, by Nestell et al. (Attorney Docket No. DON02 P-965), which is incorporated by reference in its entirety. Alternately, as described in the referenced pending application, the seal or seals may be injection molded, such as, for example, from SANTOPRENE® brand polymeric material available from Monsanto Corporation, or formed from other materials, including EPDM and thermoplastic elastomers.

Referring now to FIGS. 7-22, a horizontal slider window assembly 110 may be mounted at an opening of a vehicle (not shown). Slider window assembly 110 comprises a modular assembly that includes a pair of fixed window panes or panels 112 and a movable or slidable window pane or panel 114 that slides or moves generally horizontally relative to the fixed window panels 112 to open and close the slider window assembly, such as in a similar manner as described above. Similar to window assembly 10, the fixed window panels 12 of window assembly 110 are spaced apart and positioned at opposite sides with an opening or gap defined between the fixed window panels 112, whereby the opening is opened and closed by moving the slidable window panel 114, which is movably positioned at the inner surfaces 112a of fixed window panels 112. The slidable window panel 114 is movable or slidable generally horizontally along and between an upper rail 122 and a lower rail 124. The window assembly 110 thus may be substantially similar to window assembly 10, discussed above, such that a detailed discussion of the functioning of the window assembly and preferred materials for the components will not be repeated herein.

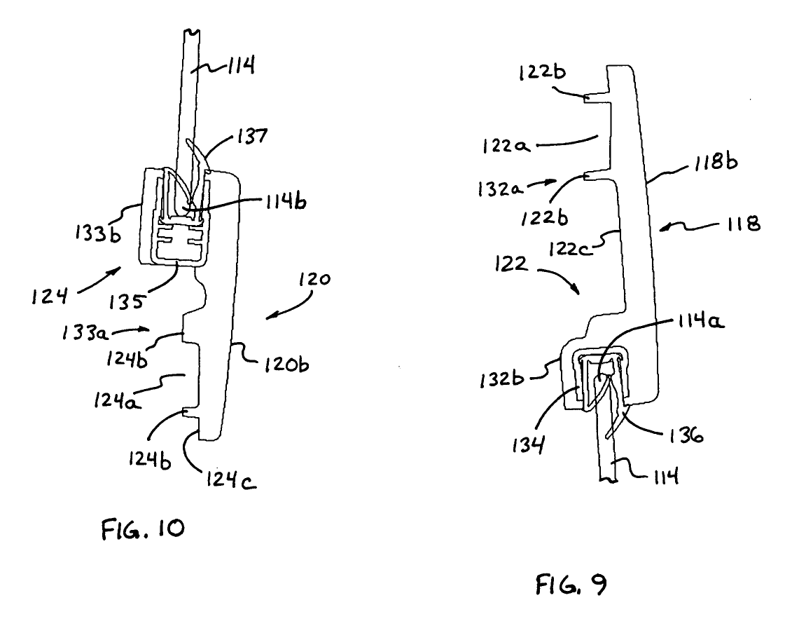

As shown in FIGS. 7-12, 14 and 18, slidable window panel 114 may be guided and supported along the substantially rigid or bracing rails 122, 124 that are mounted to the inner surfaces 112a of fixed window panels 112, such as, for example, by an adhesive or the like, such as the types described above. Each of the rails 122, 124 includes a base or mounting portion 132a, 133a and a channel or track or encapsulation 132b, 133b, along which an upper perimeter edge 114a and lower perimeter edge 114b, respectively, of movable window panel 114 is received as to guide and support the movable window panel 114 along the respective rails 122, 124. Each channel or track 132b, 133b includes a sliding seal or sealing member or element 136, 137, which substantially seals against the respective perimeter region of the movable window panel as it is moved along the rails 122, 124, respectively. As shown in FIGS. 9-12, 14 and 18, the channels or tracks 132b, 133b may also include respective inner rails 134, 135, such as substantially rigid metallic or plastic inner rails or the like, along the channels or tracks so that the sealing members 136 are received within the inner rails 134, 135, which in turn are received within (or co-extruded with) the channels or tracks 132b, 133b, respectively. The rails, including the tracks, inner rails and seals may be formed or extruded in a similar manner as noted above with respect to window assembly 10.

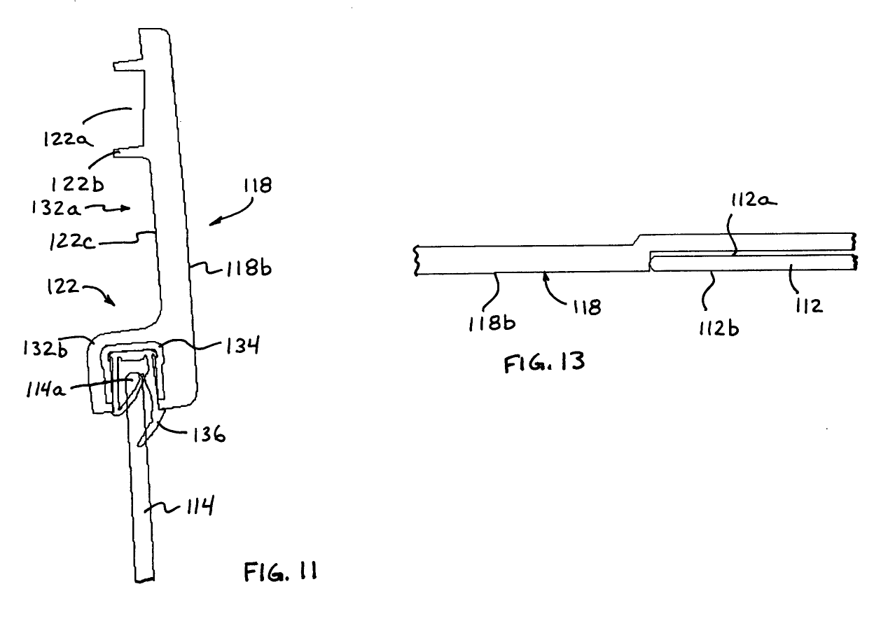

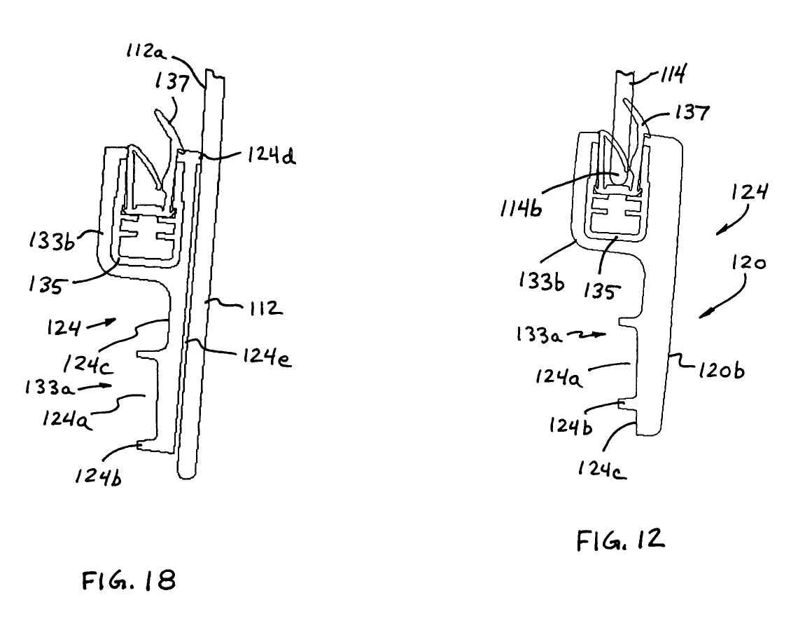

As shown in FIGS. 9 and 10, the base portions 132a, 133a of upper and lower rails 122, 124 are integrally molded or extruded (or otherwise formed) with the center upper and lower perimeter panel portions 118, 120 (such as in a similar manner as described above with respect to FIG. 6A). It should be noted that FIGS. 11 and 12 show similar sectional views as FIGS. 9 and 10, but with variations in the base of the channels or tracks, which may be established for mounting purposes, drainage purposes, clearance purposes, molding/extruding purposes and/or the like, without affecting the scope of the present invention. Because the upper and lower perimeter panel portions 118, 120 are formed with and as part of the upper and lower rails 122, 124, the upper and lower rails may be bonded or adhered or otherwise attached to the interior surface 112a of fixed window panels 112, while the upper and lower perimeter panel portions 118, 120 fit between the opposed end regions or edges of the fixed window panels 112 to provide the desired center panels at and between the fixed window panels 112. As can be seen with reference to FIG. 13, the thickness of the base portions 132a, 133a and the respective upper and lower panel portions 118, 120 may be such that an outer or exterior surface 118b of upper panel portion 118 may be substantially flush with the outer surface 112b of the fixed window panels 112 (only the upper rail and panel are shown in FIG. 13, but the outer or exterior surface 120b of lower panel portion 120 may be substantially flush with the outer surface 112b of the fixed window panels in a similar manner).

Upper and lower rails 122, 124 each include a mounting channel 122a, 124a defined by a pair of protrusions 122b, 124b that extend substantially along the interior surface 122c, 124c of the base or mounting portion 132a, 133a of the respective rail 122, 124. Mounting channels 122a, 124a may receive a bead or layer of adhesive, such as a urethane adhesive, including one part or two part urethane adhesive, an epoxy adhesive, an acrylic adhesive, a silicone adhesive, a polyvinylbutyral adhesive, or the like, or such as a butyl adhesive (as discussed below), which may be sandwiched between the mounting portions 132a, 133a of rails 122, 124 and the vehicle body or sheet metal and within the channels 122a, 124a as the rails 122, 124 and window assembly 110 are pressed against the vehicle body or sheet metal to secure the window assembly to the vehicle.

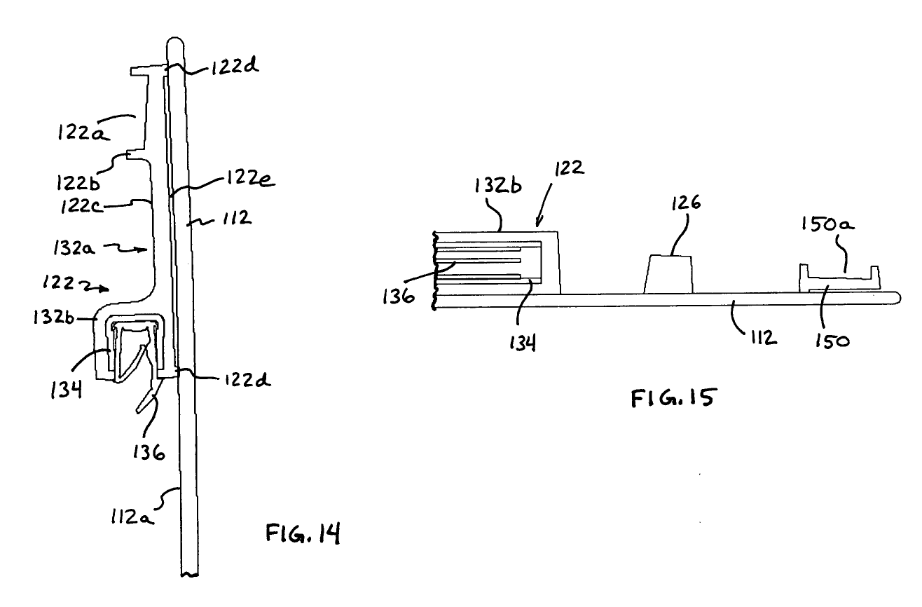

In a similar manner, the mounting or base portions 132a, 133a of rails 122, 124 (such as at the laterally outward regions from the centrally located panel portions 118, 120) may include protrusions 122d, 124d (FIGS. 14 and 18) along their opposite surfaces to define a desired or appropriate gap or channel 122e, 124e for receiving adhesive or the like between the rails 122, 124 and the fixed window panels 112. For example, the channels or gaps 122e, 124e may receive a layer of adhesive, such as a urethane adhesive, including a one part or two part urethane adhesive, an epoxy adhesive, an acrylic adhesive, a polyvinylbutyral adhesive, a silicone adhesive, or the like to adhere or bond the rails 122, 124 to the fixed window panels 112. Reference is made to U.S. Pat. Nos. 4,364,214; 4,364,595; 6,299,255; and 6,220,650, which are incorporated by reference in their entireties, for examples of suitable adhesives.

Thus, the upper traveling edge 114a and lower traveling edge 114b of slidable window panel 114 extend into the respective grooves or channels or tracks of rails 122, 124. In this manner, when slidable window panel 114 is moved to its closed position over the opening at the window assembly, movable or slidable window panel 114 is offset inwardly from the plane of the fixed window panels 112 and panel portions 118, 120 to form a “sub-flush” mounting arrangement for slidable window panel 114 with respect to fixed window panels 112 and the outer or exterior surfaces of the panel portions 118, 120.

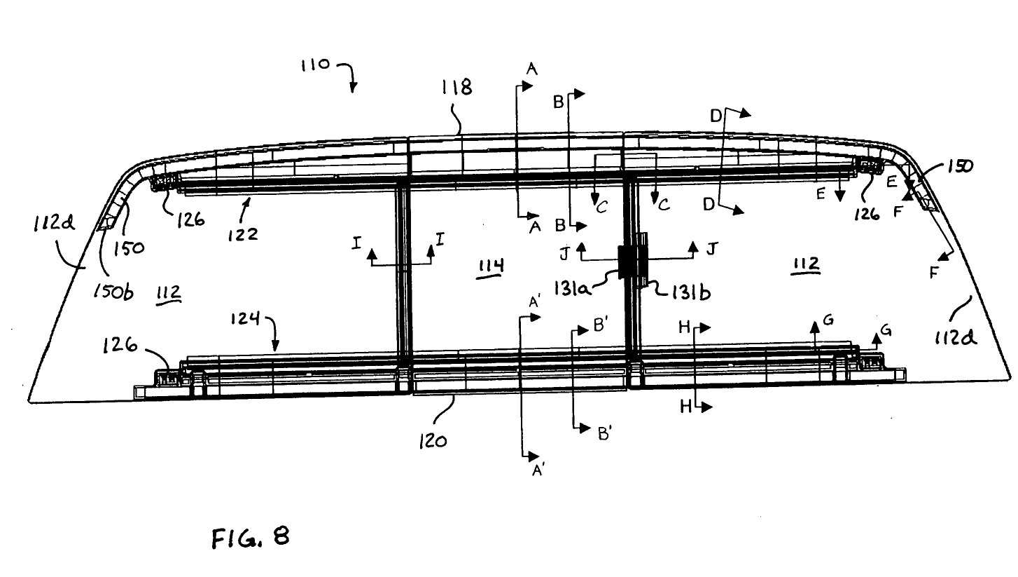

The outer or opposed surface 114c of slidable window panel 114 opposes the inner surfaces 112a of the fixed window panels, and is substantially sealed relative to the inner surfaces 112a of the fixed window panels 112 via vertical seal 130a, 130b at an inward perimeter region 112c of each fixed window panel 112. As shown in FIGS. 8, 19 and 20, seals 130a, 130b may be adhered to the inner or opposed surface 112a of a respective fixed window panel 112, such as along the perimeter edge regions 112c of the fixed window panels 112. The outer or opposed surface 114c of slidable window panel 114 thus slides along and seals against seals 130a, 130b of fixed window panels 112 as the slidable window panel 114 is moved between its opened and closed positions. Alternately, and less desirably, the vertical seals may be mounted at the leading and trailing edges of the slidable window panel.

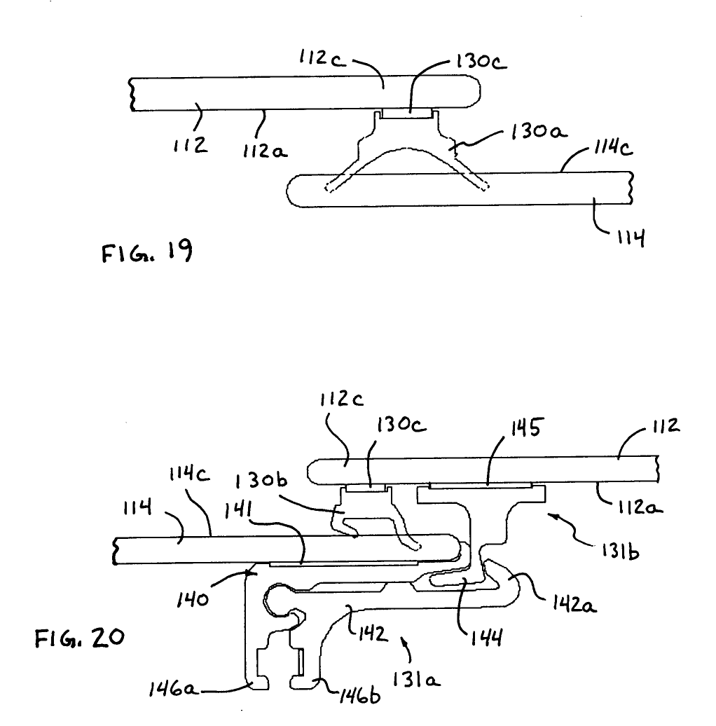

The seals 130a, 130b may comprise an extruded EPDM material or the like, and may be adhered to the inner surfaces of the fixed window panels, such as via a pressure sensitive or PS tape 130c or the like. The seals may provide a vertical seal along the sides of the opening to seal against the slidable window panel 114. Seals 130a, 130b may comprise Y-shaped seals (as shown in FIGS. 19 and 20) or bulbous seals or one or more of the various other shaped seals noted above, without affecting the scope of the present invention. Reference is made to U.S. patent application Ser. No. 10/113,056, filed Apr. 1, 2002 by Nestell et al., entitled HORIZONTAL SLIDER WINDOW ASSEMBLY, (Attorney Docket No. DON02 P-965), which is incorporated by reference in its entirety. Alternately, as described in the referenced pending application, the seal or seals may be injection molded, such as, for example, from SANTOPRENE® brand polymeric material available from Monsanto Corporation, or formed from other materials, including EPDM and thermoplastic elastomers.

Slidable window panel 114 thus moves along rails 122, 124 to open and close the window assembly. As shown in FIGS. 7, 8 and 20, slidable window panel 114 includes a latch or locking device 131a that latches to or connects to a catch or locking element 131b at one of the fixed window panels 112 to retain the slidable window panel 114 in its closed position relative to the fixed window panels 112. The latch and catch may be attached or adhered or bonded to the respective window panels, such as via an adhesive or the like. In the illustrated embodiment of FIGS. 7-22, latch 131a includes a base portion 140 that is adhered or bonded or taped or otherwise affixed to the interior surface 114d of slidable window panel 114, such as via a pressure sensitive tape 141 or the like. The base portion 140 pivotally receives a pivotable locking member 142, which includes a tab or lip 142a for releasably engaging a tab or lip 144 of the locking element 131b, which is adhered or bonded or taped or otherwise affixed to the interior surface 112a of fixed window panel 112, such as via a pressure sensitive tape 145 or the like.

The base portion 140 and the locking member 142 may include respective grasping portions 146a, 146b so that a user may readily grasp the grasping portions 146a, 146b and squeeze them together to pivot locking member 142 to release the tab or lip 142a from the tab or lip 144. The locking member 142 may be biased, such as via a spring or the like, toward its engaged position, so that upon release of the grasping portions 146a, 146b, the locking member 142 is urged toward the orientation shown in FIG. 20. For example, a spring (not shown in FIG. 20) may be positioned between the opposed surfaces of the grasping portions to urge the grasping portions apart and thus to urge the locking member toward engagement with the locking element at the fixed window when the movable window is in its closed position.

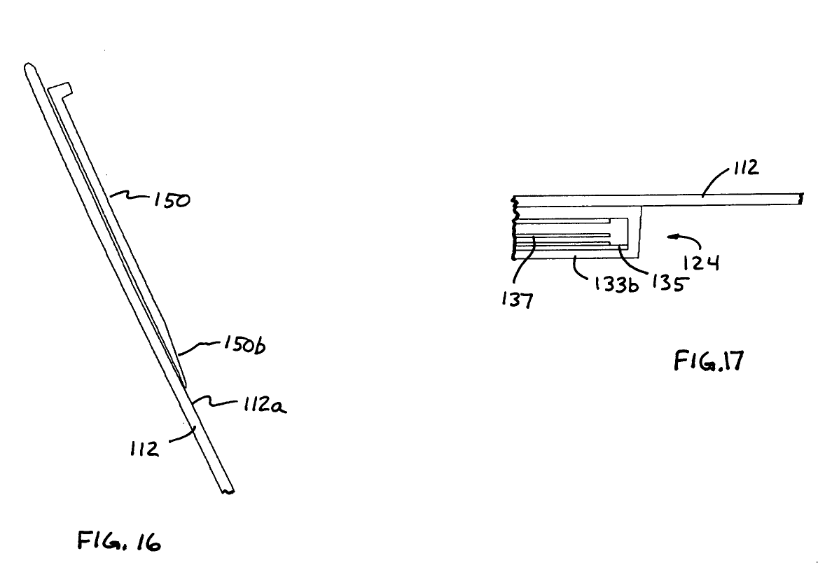

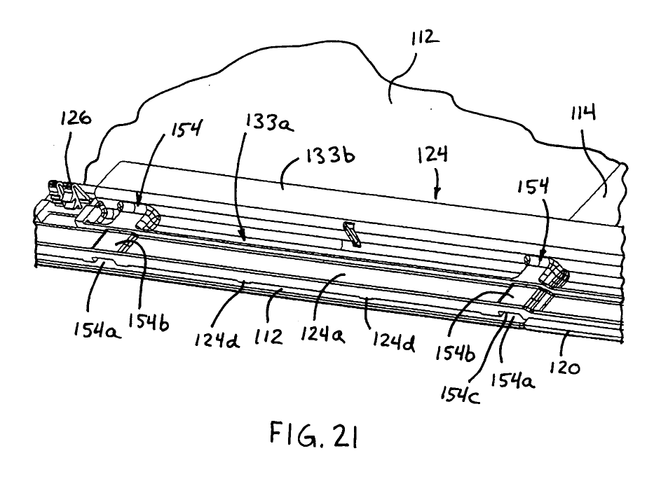

Optionally, and as shown in FIGS. 7, 8 and 15, window assembly 110 may include corner mounting portions 150 at the opposite upper corners of the fixed window panels and generally at the opposite ends of the upper rail 122. The curved corner mounting portions 150 may be attached at the opposite ends of upper rail 122 or may be integrally formed at the ends of the upper rail to provide an attachment channel 150a along the opposite upper corners of the fixed window panels for receiving a layer or bead of adhesive to enhance the attachment of the window assembly to the vehicle body or sheet metal (such as in a similar manner as described above with respect to mounting channel 122a of upper rail 122). As shown in FIGS. 7 and 16, the corner mounting portions 150 may taper or decrease in thickness toward their ends 150b to provide a generally tapered attachment surface for substantially uniformly engaging the vehicle body or sheet metal, whereby the fixed window panel 112 may be adhered or attached directly to the vehicle body or sheet metal along the opposite side perimeter regions 112d and generally below the tapered ends 150b of the corner mounting portions 150. Optionally, the window assembly may include locating and/or attaching tabs or clips or elements 126 (FIGS. 7, 8, 15 and 21) to assist an operator in locating the window assembly relative to the vehicle body or sheet metal to assist in installing the window assembly to the vehicle. Preferably, and as can be seen in FIG. 21, the clips 126 may comprise a ratchet clip design, so that they may be pressed into corresponding openings or the like at the vehicle body or sheet metal or frame, such that the window assembly may be “pushed into” the vehicle body or sheet metal or frame from the outside of the vehicle to install/attach the window assembly to the vehicle.

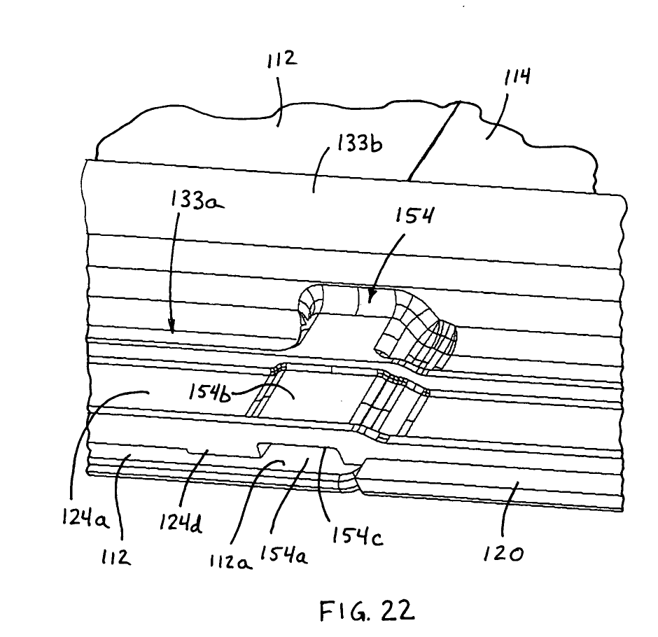

Optionally, and as can be seen with reference to FIGS. 7, 21 and 22, window assembly 110 may include one or more drainage elements 154 positioned or spaced along lower rail 124 to drain water or moisture that may accumulate in the channel or track 133b out of the track and out of the window assembly 110. In the illustrated embodiment, drainage element 154 is formed as a passageway 154a through the mounting or base portion 133a to provide a conduit or passageway for fluid to flow from the channel or track 133b to the bottom of the window assembly 110. In order to accommodate the passageway 154a, the mounting or base portion 133a of lower rail 124 may be made thicker in the regions where the drainage elements 154 are desired to provide a sufficiently sized passageway through the lower rail to provide adequate drainage of fluid from the channel or track 133b. As shown in FIGS. 21 and 22, the thicker region of the base portion 133a may result in a raised portion or area 154b along the adhesive channel or mounting track 124a to provide a sufficient size or dimension of the passageway 154a.

In the illustrated embodiment, the drainage elements 154 are formed at the lower rail 124 at the laterally outer regions of the lower rail 124 (where the rail 124 is attached to the fixed window panels 112). The drainage passageway 154a may comprise a channel or groove 154c formed along the mating surface of the mounting or base portion 133a where the base portion 133a faces and attaches to the fixed window 112, such that the passageway 154a is defined by and between the channel or groove and the interior surface of the fixed window panel 112. As shown in FIGS. 21 and 22, the channels or grooves 154c of drainage elements 154 may be formed at the mating or attaching face of the lower rail at or between spaced part protrusions 124d, which function to provide the desired bond spacing between the attaching face of the rail 124 and the interior surface 112a of the fixed window panel 112. Optionally, it is envisioned that the drainage element 154 may be located at the central region of the lower rail 124 (where the rail 124 includes the lower panel portion 120 formed therewith), whereby the drainage passageway 154a may be formed downward through the lower rail 124 and through the mounting or base portion 133a.

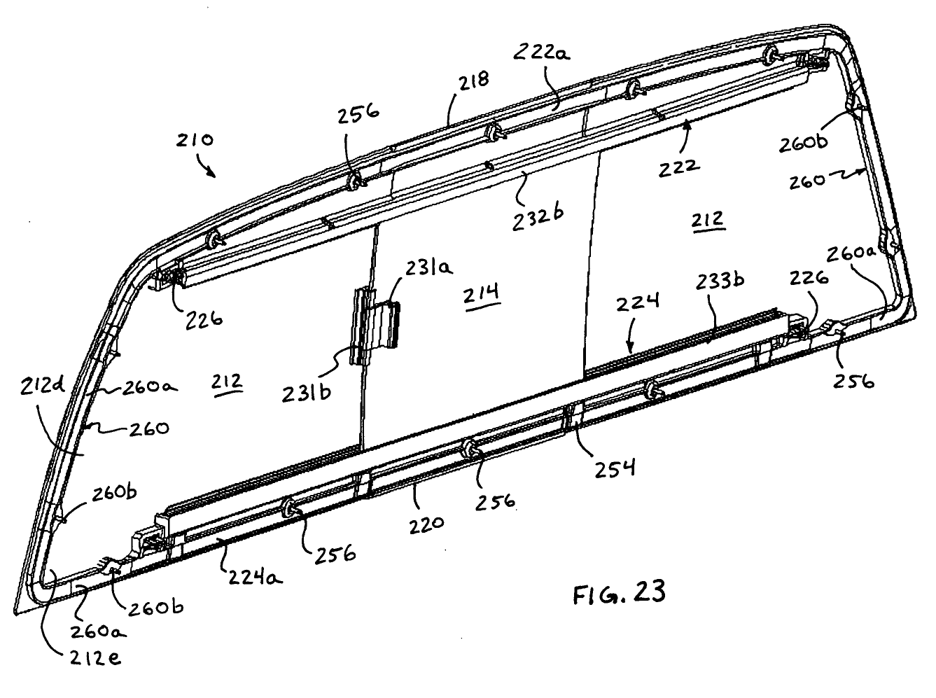

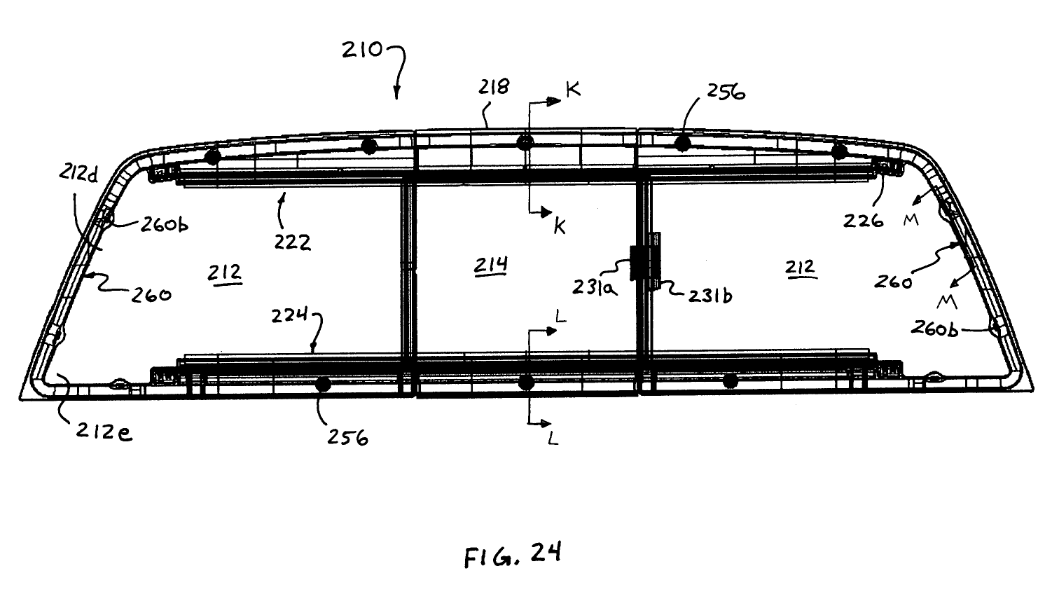

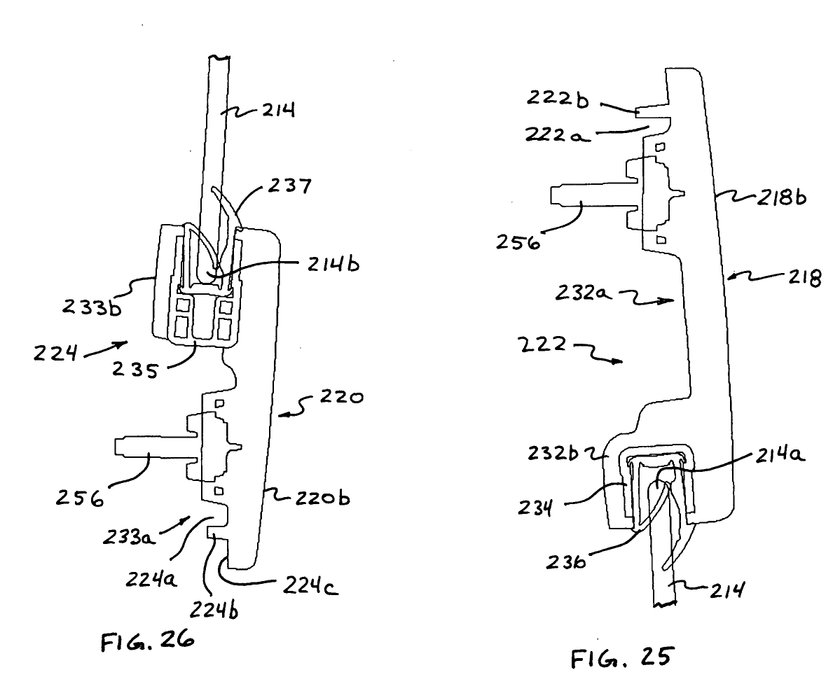

Although shown and described above as a window assembly that is bonded or adhered to the vehicle body or sheet metal via a urethane adhesive or the like, it is envisioned that other means may be implemented to attach or secure the window assembly to the vehicle. For example, and with reference to FIGS. 23-28, a horizontal slider window assembly 210 may be attached to a vehicle body or sheet metal or frame via a butyl bead or adhesive bead (not shown) and a plurality of fasteners 256, such as studs or the like, which may be secured tot eh vehicle body or sheet metal or frame via corresponding fasteners (not shown), such as female fasteners or nuts or clips or the like. The window assembly 210 includes an upper rail 222 and a lower rail 224 that are attached to spaced apart fixed window panels 212 and that have channels or tracks 232b, 233b for slidably receiving the upper and lower perimeter edges of a movable or slidable window panel 214. Window assembly 210 may be substantially similar to window assembly 110 and/or 10, discussed above, such that a detailed discussion of the window assemblies will not be repeated herein. The similar or common components or elements or features of the window assemblies are shown in FIGS. 23-28 with similar reference numbers as used in FIGS. 7-22, but with 100 added to the reference numbers of FIGS. 7-22.

As shown in FIGS. 23, 25 and 26, the rails 222, 224 may have the studs 226 insert molded or otherwise fixedly secured within the mounting or base portions 232a, 233a of the rails 222, 224, so that the studs 226 protrude outwardly from the mounting surface of the rails for insertion into and attachment to the vehicle body or sheet metal or frame or the like. The studs 226 may be located and spaced apart along a bead receiving channel 222a, 224a of the upper and lower rails 222, 224, respectively.

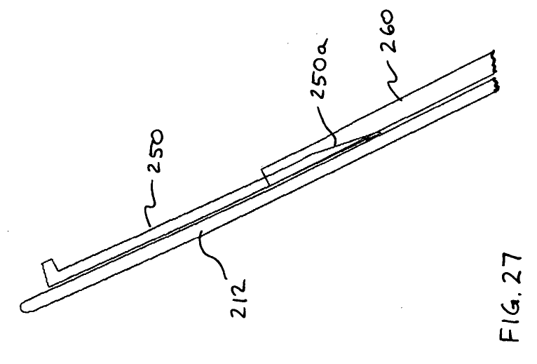

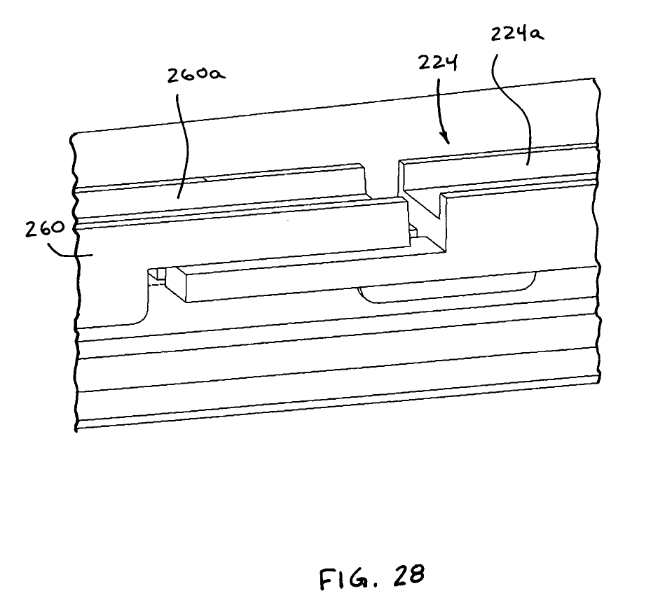

In the illustrated embodiment, window assembly 210 includes a perimeter mounting portion 260 that extends along the side perimeter regions 212d and opposite lower corner regions 212e of the fixed window panels 212 so as to provide a mounting surface with a bead receiving channel 260a extending therealong and fasteners or studs 260b protruding therefrom. The perimeter mounting portion 260 thus provides a mounting or engaging surface for engaging and attaching to the vehicle body or sheet metal or frame at the opposite perimeter portions of the window assembly to enhance the attachment and securement of the window assembly to the vehicle. As shown in FIGS. 27 and 28, the ends of the perimeter mounting portions 260 may be joined at the ends of the respective upper and lower rails 222, 224 to provide a substantially continuous perimeter rail around the window assembly 210. As shown in FIG. 27, the upper end 260c of perimeter mounting portion 260 may overlap the tapered end 250b of the corner mounting portion 250 at the upper and laterally outward corner of the fixed window panel 212. As shown in FIG. 28, the lower end 260d of perimeter mounting portion 260 may overlap a respective end of the lower rail 224, and may overlap in a manner that the bead receiving channels 224a, 260a are substantially aligned with one another such that a substantially continuous butyl bead or rope may be received in the channels around the perimeter of the window assembly.

The window assembly or module of the present invention provides enhanced assembly processing of the window assembly and reduced labor. Because the frame or rails of the window assembly do not include the rigid or solid vertical interconnecting rails or bars extending between the upper and lower rails, the separate upper and lower rails may be readily positioned on the window panels, and the vertical seals may be readily adhered to the window panels in the appropriate locations. Due to the separate upper and lower rails, the rails of the window assembly of the present invention may be handled by a single operator and readily applied to or bonded to or molded to the window panels. Also, because the rails are not joined together by vertical rigid frame portions, the separate upper and lower rails of the window module of the present invention may be molded in multi-cavity molds, such as in a side by side arrangement, so that multiple rails may be molded in a single molding process. Such molding processes may substantially enhance the manufacture and assembly of the window modules of the present invention.

Thus, the process of assembling the horizontal slider window assembly may include first adhering or gluing or bonding the lower (or upper) rail (which may already include the inner rail and seal therein) to the fixed window panels. The slidable window panel may then be received in the channel and the upper (or lower) rail may be positioned at the upper (or lower perimeter edge of the slidable window panel and then adhered or bonded to the fixed window panels. The vertical seals and the latch or catch mechanism may then be taped or adhered or bonded to the surface of the fixed window panels to complete the assembly. Because the vertical seals are taped or adhered or bonded to the surface of the fixed window panels and there are no vertical bracing rails or elements, the window assembly of the present invention thus does not have a predetermined central window aperture and thus can be readily assembled by an operator or operators without requiring mating or joining the rails and attaching the rails to the window panels at a precise location to provide the predetermined window aperture at the precise location at the window assembly. The assembly process thus may be readily performed by one or more operators at a window assembly plant or facility or the like, whereby the completed window assembly may then be readily installed or attached to the vehicle at a vehicle assembly plant or facility or the like.

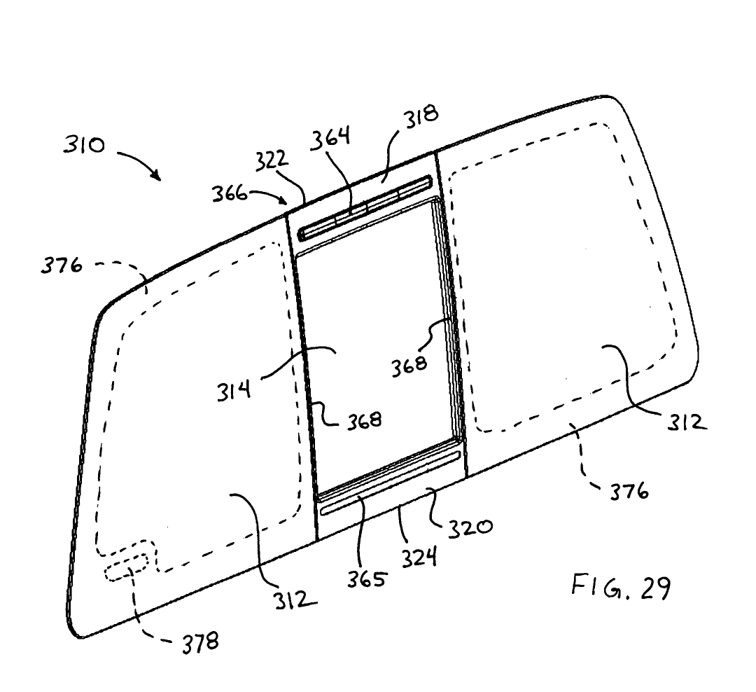

Optionally, the horizontal slider window assembly may include an illumination source at the upper and/or lower panel portions of the window assembly, so as to selectively provide illumination at the rear of the vehicle cabin, such as for a center high mounted stop lamp or for a pickup bed light or the like. For example, and as shown in FIGS. 29-31, a rear horizontal slider window assembly 310 includes an illumination source 364 positioned at and integral with an upper panel portion or header portion 318. Window assembly 310 includes a pair of fixed window panels 312 and a movable window panel 314 that is movable along an upper track or channel or rail 322 and a lower channel or track or rail 324 and relative to the fixed window panels 312, such as in a similar manner as described above. In the illustrated embodiment, window assembly includes a frame portion 366 that includes upper rail 322 and upper header panel portion 318 and lower rail 324 and lower panel portion 320 and a pair of vertical frame portions or legs 368 that combine or cooperate to define the window opening of the window assembly. However, although shown in FIGS. 29-31 as having vertical frame portions, the illumination source of the present invention may be implemented at an upper panel portion (or lower panel portion or elsewhere at the window assembly as discussed below) of a window assembly of the types described above, without affecting the scope of the present invention.

In the illustrated embodiment, upper rail 322 includes a header portion 332a and a channel or track portion 332b, such as similar to upper rails 22, 122, 222 described above. Channel portion 332b includes an inner rail member 334, which in turn has a seal or sealing member (not shown) along the rail for movably or slidably sealing against the upper perimeter edge region 314a of movable window panel 314. As shown in FIG. 31, upper rail 322 may comprise a generally hollow rail and, thus, may provide an inner cavity for receiving or partially receiving illumination source 364 therealong. The wires 364a or cables or conductive elements for connecting the illumination source 364 to a power supply and/or control of the vehicle may be readily routed through the hollow rail and may pass through an inner portion of the rail, such as a mounting surface or portion 322a of upper rail 322, for electrical connection to a vehicle wire harness or wiring (not shown) or the like. However, the upper rail may be molded or extruded and thus may be a substantially solid member, such as described above, with a wiring passageway formed therethrough or with electrical or conductive terminals or elements insert molded or integrally molded within the rail portion, such as by utilizing aspects described in U.S. Pat. No. 6,227,689, which is hereby incorporated herein by reference. By feeding the wire into the upper rail at the mounting portion or surface of the rail, the wire is substantially hidden from view and may be readily connected to a vehicle wire harness (such as a vehicle wire harness with connector that is readily accessible at the vehicle, such as at or in the vehicle headliner at the rear of the cabin and generally at an upper region of the window assembly when the window assembly is attached to the vehicle) as the window assembly is installed at the vehicle. Optionally, the wiring of the illumination source may be readily electrically connected to the vehicle wiring as the window assembly is attached to the vehicle, such as by utilizing aspects of the cap assembly described in U.S. Pat. No. 6,669,267, which is hereby incorporated herein by reference. Preferably, the upper panel portion 318 may be substantially opaque, such as a dark color or the like, so that the wires and channel and the like are not viewable through the upper panel portion 318 of upper rail 322.

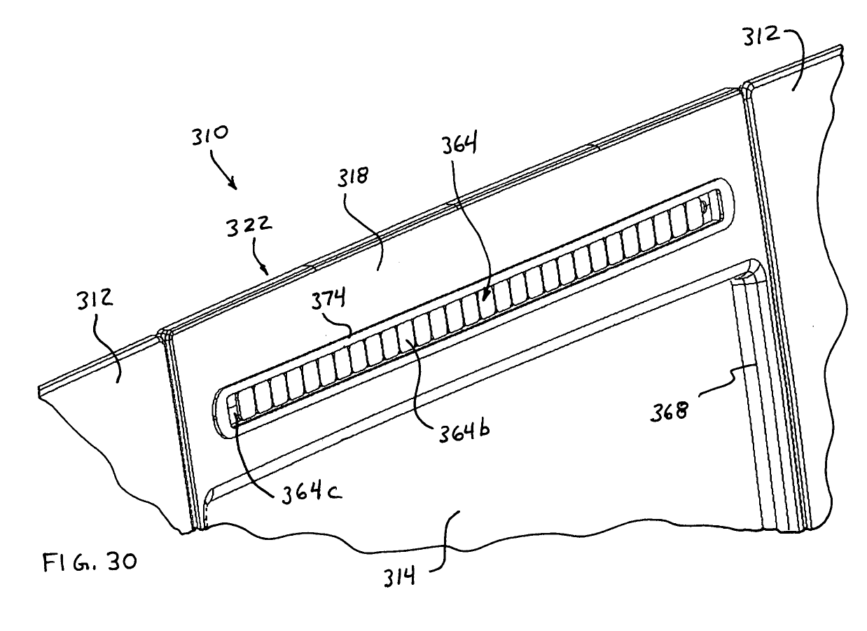

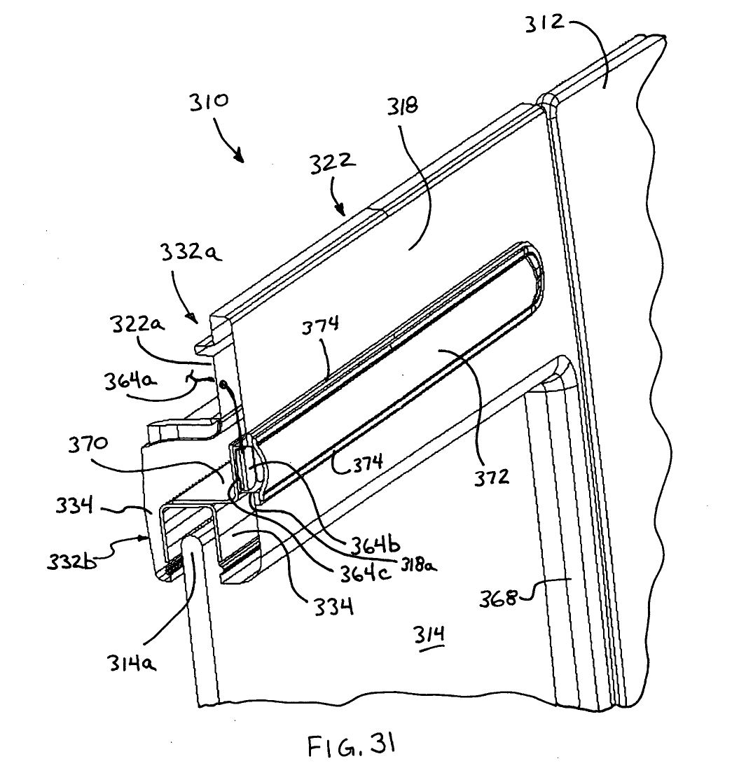

As shown in FIGS. 30 and 31, illumination source 364 may comprise a plurality of lights or illumination sources or elements, such as a plurality of light emitting diodes 364b (LEDs) positioned along an LED board or strip 364c that is located generally horizontally across the header panel portion 318 of window assembly 310. For example, and with reference to FIG. 31, illumination source 364 (such as the board 364c of illumination source 364) may be mounted to a mounting bracket or rail or flange 370 that is mounted or attached or welded to the inner rail member 334 of the upper channel 332b. In the illustrated embodiment, the LEDs 364b may be positioned along the upper rail and generally at a generally horizontal slot or opening 318a formed in the upper panel portion 318. As can be seen in FIG. 31, a cover or lens 372 may be attached (such as by snapping onto the upper rail or otherwise attaching to the upper rail) over the illumination sources and sealed to the surface of the upper panel portion 318 via a sealing gasket 374 or the like, so as to limit or substantially preclude water intrusion or the like at the cover or lens 372.

The illumination source 364 may comprise a brake light, such as for a center high mounted stop lamp of the vehicle, whereby the illumination source may be activated upon actuation of the vehicle brakes. Optionally, and alternately, the illumination source may comprise an illumination source or light for illuminating the bed of the pickup, such as one or more lights that are directed so as to provide white (or substantially white) light or illumination to illuminate the pickup bed, such as in response to a user input or button or switch. Optionally, the window assembly 310 may also or otherwise include an illumination source 364 for a center high mounted stop lamp at the upper rail 322 and may include a second illumination source 365 (such as for providing light to the pickup bed) at the lower rail 324. The lower illumination source 365 may be substantially similar as illumination source 364 described above, such that a detailed discussion of the illumination sources will not be repeated herein.

As shown in FIG. 29, the fixed window panels 312 may include an opaque or substantially opaque perimeter coating or layer 376, such as a black frit layer or the like. Optionally, an illumination source 378 may be located at an outer corner of the window assembly 310, such as to provide a turn signal indicator or pickup bed illumination or the like at the outer ends or sides of the window assembly. The illumination source 378 may be located at the opaque layer 376 (and a window or non-opaque region may be established at the illumination source), and may extend into a side mounting or frame portion of the window assembly, such as in a similar manner as described above with respect to illumination source 364. Although shown at a lower left corner of the fixed window panel of the window assembly 310, clearly one or more illumination sources may be located at other locations at the window assembly, such as at both sides of the window assembly and/or at an upper corner or corners of the window assembly or the like, without affecting the scope of the present invention.

Therefore, an illumination source may be implemented with a rear horizontal slider window assembly, whereby the illumination source may be readily viewable at the window assembly with the wiring and attachment brackets within the window assembly and not readily viewable by a person viewing the window assembly at a vehicle. The mounting portions of the illumination source or sources and the electrical wiring of the illumination source or sources may be positioned within the frame of the window assembly, whereby the illumination source or sources may be readily electrically connected to a wiring harness of the vehicle as the window assembly is installed at the vehicle. Because the illumination source is positioned partially within the frame portion of the window assembly or behind the fixed window panel of the vehicle, the illumination source of the present invention provides a flush or substantially flush illumination source at the rear slider window assembly.

Although shown and described as a horizontal slider window assembly, it is envisioned that aspects of the present invention are equally suited for applications with a vertical slider window assembly. Also, although shown and described as having a pair of spaced apart fixed window panels and upper and lower panes or panels, the window assembly may include other panel arrangements, such as a single fixed window panel with an opening formed therein or the like, without affecting the scope of the present invention.

Therefore, the present invention provides a slider window assembly or module for a vehicle that does not include frame portions along the junction or sealing region between the fixed and movable or slidable window panels. The window assembly includes a seal or sealing member that is adhesively attached to or bonded to one of the opposed surfaces of the slidable window panel and the fixed window panel or panels to provide a sliding seal between the panels. The slidable window panel may slide over the seal adhesively attached to or bonded to the fixed window panel or the slidable window panel may include a seal adhesively attached to or bonded to the surface of the slidable window panel such that the seal slides along the fixed window panel as the slidable window panel is opened and closed. The window assembly of the present invention thus provides a sliding window assembly with reduced frame portions and thus provides a reduced cost and reduced weight window assembly. Also, the rails of the window assembly may be molded in multiple cavity molds, such that multiple rails may be molded during a single molding process, thereby reducing the manufacturing time and costs and molding equipment requirements. Also, the window assembly may include one or more illumination sources positioned at and/or partially within a frame portion of the window assembly.

Changes and modifications to the specifically described embodiments may be carried out without departing from the principles of the present invention, which is intended to be limited only by the scope of the appended claims as interpreted according to the principles of patent law.

1. A window assembly for a vehicle, said window assembly comprising:
at least one fixed window panel having a perimeter edge that defines at least a portion of an opening;
a movable window panel that is movable relative to said at least one fixed window panel to open and close said opening, said movable window panel and said fixed window panel having opposed surfaces; and
at least one sealing member, said at least one sealing member being attached to one of said opposed surfaces and slidably engaging the other of said opposed surfaces as said movable window panel is moved relative to said at least one fixed window panel.

2. The window assembly of claim 1, wherein said at least one sealing member is attached to a surface of said at least one fixed window panel, said at least one sealing member slidably engaging the surface of said movable window panel as said movable window panel is moved.

3. The window assembly of claim 1, wherein said sealing member comprises an extruded elastomeric sealing member.

4. The window assembly of claim 1, wherein said sealing member is adhesively attached to said one of said opposed surfaces.

5. The window assembly of claim 1 including an upper rail member and a lower rail member attached to said at least one fixed window panel, said movable window panel moving along said upper and lower rail members.

6. The window assembly of claim 1, wherein said at least one fixed window panel comprises first and second window panels spaced apart from one another with said opening defined therebetween.

7. The window assembly of claim 6 including upper and lower panels positioned between said first and second window panels and defining upper and lower margins of said opening.

8. The window assembly of claim 7 including an upper rail member and a lower rail member attached to said first and second window panels and said upper and lower panels, said movable window panel moving along said upper and lower rail members.

9. The window assembly of claim 8, wherein said rail members are bonded to said first and second window panels and said upper and lower panels.

10. The window assembly of claim 8, wherein said upper rail member is integrally formed with said upper panel and said lower rail member is integrally formed with said lower panel.

11. The window assembly of claim 1, wherein said movable window panel is moved generally horizontally.

12. A window assembly for a vehicle, said window assembly comprising:
first and second fixed window panels, said first and second fixed window panels having opposed perimeter edges that define at least a portion of an opening;
a movable window panel that is movable relative to said at least one fixed window panel to open and close said opening, said first and second fixed window panels having first surfaces that oppose a second surface of said movable window panel;
an upper rail attached to said first surfaces of said first and second fixed window panels and extending along an upper region of said first and second fixed window panels;
a lower rail attached to said first surfaces of said first and second fixed window panels and extending along a lower portion of said first and second fixed window panels, said upper and lower rails comprising respective channels for slidably receiving said movable window panel so that said movable window panel is movable along said upper and lower rails; and
a first sealing member attached to said first surface of said first window panel and generally along said opposed perimeter edge of said first window panel and a second sealing member attached to said first surface of said second window panel and generally along said opposed perimeter edge of said second window panel, said first and second sealing members slidably engaging said second surface of said movable window panel as said movable window panel is moved along said upper and lower rails.

13. The window assembly of claim 12, wherein said first and second sealing members comprise extruded elastomeric sealing members.

14. The window assembly of claim 12, wherein said first and second sealing members are adhesively attached to said first surfaces of said first and second window panels.

15. The window assembly of claim 12, wherein said upper rail and said lower rail include upper and lower panels positioned between said first and second window panels and defining upper and lower margins of said opening.

16. The window assembly of claim 15, wherein said upper and lower panels have a third surface that is substantially flush with a fourth surface of said first and second fixed window panels, said fourth surface being generally opposite to said first surface of said first and second fixed window panels.

17. The window assembly of claim 15, wherein said rail members are bonded to said first and second window panels and said upper and lower panels.

18. The window assembly of claim 15, wherein said first and second rail members are integrally formed with said upper and lower panels.

19. The window assembly of claim 12, wherein said movable window panel is moved generally horizontally.
